(19) United States
(12) Patent Application Publication
(10) Pub. No.: US 2006/0114904 A1
(43) Pub. Date: Jun. 1, 2006

(54) Differentiated services multicast system and method using encapsulation and unicast

(76) Inventor: Ji-Eun Lee, Suwon-si (KR)

Correspondence Address: Robert E. Bushnell, Suite 300, 1522 K Street, N.W., Washington, DC, 20005-1202, US

(21) Appl. No.: 11/281,435

(22) Filed: Nov. 18, 2005

(30) Foreign Application Priority Data
Nov. 26, 2004 (KR) 2004-98243

(51) Int. Cl. H04L 12/56

(52) U.S. Cl. 370/390

(57) ABSTRACT

A DiffServ multicast system and method includes: searching a routing table according to information of a header of a multicast packet to determine the number of routers capable of transmitting the multicast packet upon the multicast packet being received; copying the multicast packet to correspond to the number of routers determined to be capable of transmitting the multicast packet upon the multicast packet being received; and checking an entry connected to the next router through the routing table, setting a flag of each entry stored in the header of the multicast packet, and transmitting the multicast packet.

### CLAIM OF PRIORITY

This application makes reference to, incorporates the same herein, and claims all benefits accruing under 35 U.S.C. § 119 from an application for DIFFERENTIATED SERVICES MULTICAST SYSTEM AND METHOD USING ENCAPSULATION AND UNICAST earlier filed in the Korean Intellectual Property Office on Nov. 26, 2004 and there duly assigned Serial No. 10-2004-0098243.

### BACKGROUND OF THE INVENTION

1. Field of the Invention

The present invention relates generally to a Differentiated Services (DiffServ) multicast system and method, more particularly, to a DiffServ multicast system and method using encapsulation and unicast for providing an architecture of the Diffserv which improves performance in comparison with existing mechanisms without being contrary to two concepts of the DiffServ and the multicast.

2. Description of the Related Art

DiffServ is an architecture of classifying flows requiring a similar kind of Quality of Service (QoS) into one class to thus provide services by class.

On a network, border routers perform all of the functions of controlling traffic. As such, core routers may secure scalability by providing services only at the sight of the class without information on QoS of each flow.

However, it is the removal of the flow information from the core routers for the purpose of securing scalability that makes it difficult for multicast in the DiffServ to be supported.

Firstly, in order to provide multicast services, information is required on a multicast tree of a group in question, and information is required on a level of the service which must be provided in passing through a branch of the tree.

However, if such information is stored in the core routers of the DiffServ, this is contrary to a concept of the DiffServ in that no flow information should exist in the core routers. Thus, a problem on the scalability occurs.

Secondly, the DiffServ is a mechanism of a sender determining QoS and necessary resources to make a contract with an Internet Service Provider (ISP), that is, to a company that makes it possible for general users, other companies, organizations, groups, etc. to provide access to the Internet. For example, Korea Telecom initiated Internet commercial services targeting general citizens on June 1994, and so became the first ISP in Korea. Thereafter, with a rapid increase in the use of the Internet, many ISPs, such as Dacom, Korea PC Communication, INet Technology provided Internet services, being assigned the resources and making use of the resources.

As such, the DiffServ has a concept opposite to a multicast service where services are provided by a receiver requesting desired services. Owing to features of the multicast where members freely join and leave a group, the DiffServ leads to using the resources to a greater extent than the contract which the sender has made with the ISP. As a result, a problem of interrupting existing traffic occurs.

In order to support multicast services in the DiffServ, simplicity of the core router, which is a basic concept of the DiffServ should be maintained, and simultaneously, service demands of receivers which require various QoSs and repeat joining and leaving of the group at any time should be satisfied.

Conventionally, methods proposed to satisfy these conditions are as follows.

The first is to store information of the group in the core router on the basis of the existing IP multicast, and the second is to support multicast services using several unicast packets.

For the method of applying the existing IP multicast without any change as mentioned above, tree information for the multicast must be stored in all of the routers of the DiffServ. The method is adapted to look for information of the corresponding group when the multicast packet arrives to perform the multicast.

Accordingly, the conventional method of using the IP multicast makes the utmost use of the existing IP multicast, thereby enjoying advantages of maintaining a saving of bandwidth, as an advantage of the multicast, as it stands, and for guaranteeing various QoSs. Furthermore, this method is adapted to prevent existing traffic from being interrupted by allowing the members to freely join to the group to use the resources before making a contract with the ISP.

However, the conventional method of using the IP multicast has a problem of violating the basic concept of the DiffServ in that the core router should not contain any information on the flow.

In addition, whenever the group is generated or deleted and whenever the members join or leave the group, the contents of the core router must be changed. Consequently, the scalability problem remains unchanged in a large network.

Thus, the conventional method as mentioned above is available only when multicast traffic is less than unicast traffic, or when the group is in a domain or its members are static.

The second method can support the multicast in a DiffServ domain with a core router incapable of copying the packet, and can easily maintain the core router, thus being suitable for the concept of the DiffServ.

However, use of this method causes saving of the bandwidth known as the advantage of the multicast to be sacrificed.

In particular, in the case of a domain having dense service groups and being composed of many members, the loss of the bandwidth is destined to be increased.

Thus, in order to use this method, a technique for using the bandwidth to the minimum is required.

### SUMMARY OF THE INVENTION

It is, therefore, an object of the present invention to provide a DiffServ multicast system and method using encapsulation and unicast having a structure to improve the overall performance by distributing a load concentrated on an ingress router within a DiffServ domain to cope with a change of a network or group in a rapid and flexible manner.

In order to accomplish one object according to an aspect of the present invention, a Differentiated Services (DiffServ) multicast method using encapsulation and unicast is provided, the method comprising: searching a routing table according to information of a header of a multicast packet to determine the number of routers capable of transmitting the multicast packet upon the multicast packet being received; copying the multicast packet to correspond to the number of routers determined to be capable of transmitting the multicast packet upon the multicast packet being received; and checking an entry connected to the next router through the routing table, setting a flag of each entry stored in the header of the multicast packet, and transmitting the multicast packet.

The multicast method preferably further comprises transmitting the received multicast packet to the corresponding router or receiver upon the number of next routers capable of transmitting the multicast packet having been determined to be one.

Searching a routing table according to information of a header of a multicast packet to determine the number of routers capable of transmitting the multicast packet upon the multicast packet being received preferably comprises: receiving the multicast packet; determining whether or not a tree encapsulation header exists in the multicast packet; determining the states of flags of all of the entries stored in the tree encapsulation header of the multicast packet upon a determination that the tree encapsulation header exists in the multicast packet; and searching the routing table to determine the number of routers capable of transmitting the multicast packet upon a determination that the flags of all the entries are not activated.

The multicast method preferably further comprises: additionally generating the tree encapsulation header at a header of the multicast packet using members of a group and information on a level of requested service upon a determination that the tree encapsulation header does not exist; and activating a field of the entry of the multicast packet to be transmitted through the routing table and proceeding to searching the routing table to determine the number of routers capable of transmitting the multicast packet upon a determination that the flags of all the entries are not activated.

The multicast method preferably further comprises discarding the multicast packet upon a determination that the flags of all the entries have not been activated.

Checking an entry connected to the next router through the routing table, setting a flag of each entry stored in the header of the multicast packet, and transmitting the multicast packet preferably comprises: determining whether or not the activated entry is connected to the next router using the routing table; and maintaining the setting of the flag of the activated entry in an activated state upon a determination that the activated entry has been connected to the next router.

The multicast method further preferably comprises changing the setting of the flag of the activated entry into an inactivated state upon a determination that the activated entry is not connected to the next router,

Transmitting the received multicast packet to the corresponding router or receiver upon the number of next routers capable of transmitting the multicast packet having been determined to be one preferably comprises: determining whether a next block transmitting the multicast packet is the receiver; and removing the tree encapsulation header of the multicast packet and then transmitting the multicast packet upon a determination that the next block is the receiver.

The multicast method preferably further comprises transmitting the received multicast packet upon a determination that the next block is the router.

In copying the multicast packet to correspond to the number of routers determined to be capable of transmitting the multicast packet upon the multicast packet being received and checking an entry connected to the next router through the routing table, setting a flag of each entry stored in the header of the multicast packet, and transmitting the multicast packet, the multicast packet preferably additionally includes the tree encapsulation header.

The tree encapsulation header preferably includes position information of members, options and at least one entry.

A header of the multicast packet having the tree encapsulation header preferably includes an IP header of 20 bytes and the tree encapsulation header of 2+2E bytes.

A field of the entry in the tree encapsulation header preferably includes an identifier of a member, Quality of Service (QoS) required by the member, and flag information.

A field of the entry identifier in the tree encapsulation header preferably has 8 bits.

A field of the QoS in the tree encapsulation preferably header has 6 bits.

The flag in the tree encapsulation header preferably has 1 bit.

E in the multicast data packet preferably represents the number of egress routers in nodes constituting a multicast tree.

In order to accomplish another object according to an aspect of the present invention, a Differentiated Services (DiffServ) multicast method using encapsulation and unicast is provided, the method comprising: generating a tree encapsulation header at a header of a multicast packet using members of a group and information on a level of requested service upon an ingress router receiving the multicast packet; determining, through search of a routing table, whether the number of routers capable of transmitting the multicast packet is one or at least two by the ingress router; copying the multicast packet to correspond to the number of routers by the ingress router upon a determination that the number of routers capable of transmitting the multicast packet is at least two; and transmitting each of the copied multicast packets by the ingress router.

The multicast method preferably further comprises transmitting the received multicast packet to a next router by the ingress router upon a determination that the number of routers capable of transmitting the multicast packet is one.

In order to accomplish another object according to an aspect of the present invention, a Differentiated Services (DiffServ) multicast method using encapsulation and unicast is provided, the method comprising: determining, through search of a routing table, whether the number of routers capable of transmitting the multicast packet is one or at least two by the core router upon a core router receiving a multicast packet; copying the multicast packet to correspond to the number of next routers by the core router upon a determination that the number of next routers capable of transmitting the multicast packet is at least two; and transmitting each of the copied multicast packets by the core router.

The multicast method preferably further comprises transmitting the received multicast packet to a next router by the core router upon a determination that the number of next routers capable of transmitting the multicast packet is one.

In order to accomplish yet another object according to an aspect of the present invention, a Differentiated Services (DiffServ) multicast system using encapsulation and unicast is provided, the system comprising: an ingress router adapted to generate a tree encapsulation header upon receiving a multicast packet from a sender and to activate an entry of the tree encapsulation header to transmit the multicast packet to a next router; at least one core router adapted to check the activated entry from the tree encapsulation header, to examine a unicast routing table to copy the multicast packet by the number of next routers connectable to the activated entry, and to change an activation setting of the tree encapsulation header to transmit the copied multicast packet; and at least one egress router adapted to remove the tree encapsulation header upon receiving the multicast packet having the tree encapsulation header, and to transmit the multicast packet to each receiver.

The ingress router is adapted to preferably generate the tree encapsulation header upon receiving the multicast packet and to include the tree encapsulation header in a header of the multicast packet.

The tree encapsulation header preferably includes position information of members, options and at least one entry.

A header of the multicast packet having the tree encapsulation header preferably includes an IP header of 20 bytes and the tree encapsulation header of 2+2E bytes.

Information included in the entry in the tree encapsulation header preferably includes at least one of an identifier of a member, Quality of Service (QoS) required by the member, and flag information.

A field of the entry identifier in the tree encapsulation header preferably has 8 bits.

A field of the QoS in the tree encapsulation header preferably has 6 bits.

The flag in the tree encapsulation header preferably has 1 bit.

E in the multicast data packet preferably represents the number of egress routers in nodes constituting a multicast tree.

In order to accomplish still another object according to an aspect of the present invention, a Differentiated Services (DiffServ) multicast system using encapsulation and unicast is provided, the system comprising: an ingress router adapted to, upon routing information being changed, update information on a router tree to manage information on all multicast trees, and, upon a multicast packet being received from a sender, to search information on the corresponding multicast tree to generate a tree encapsulation header, and to store the tree encapsulation header in the multicast packet and transmit the multicast packet; and at least one core router adapted to, upon the multicast packet being received from the ingress router, parse the tree encapsulation header of the multicast packet to transmit the multicast packet to a destination.

The tree encapsulation header preferably includes position information of members, options and at least one entry.

A field of the entry preferably includes an entry identifier of 1 byte, entry information to be copied of 6 bits, and Quality of Service Information (QoS) of each entry of 3 bits.

In order to accomplish yet another object according to an aspect of the present invention, a Differentiated Services (DiffServ) multicast method using encapsulation and unicast is provided, the method comprising: transmitting an IPv6 packet; and receiving the IPv6 packet; wherein the IPv6 packet includes a tree encapsulation header.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a view of a DiffServ multicast system using encapsulation and unicast in accordance with a first embodiment of the present invention;

FIG. 2 is a view of a structure of a multicast packet according to a first embodiment of the present invention;

FIG. 3 is a flowchart showing a DiffServ multicast method using encapsulation and unicast in accordance with a first embodiment of the present invention;

FIG. 4 is a flowchart of a detailed configuration of a first step S1 in the DiffServ multicast method using encapsulation and unicast of FIG. 3;

FIG. 5 is a flowchart of a detailed configuration of a third step S3 in the DiffServ multicast method using encapsulation and unicast of FIG. 3;

FIG. 6 is a flowchart of a detailed configuration of a fourth step S4 in the DiffServ multicast method using encapsulation and unicast of FIG. 3;

FIGS. 7(a)-(f) are views of a multicast packet of each router in the DiffServ multicast method using encapsulation and unicast of FIG. 3;

FIG. 8 is a flowchart of an operation of an ingress router in a Diffserv multicast method using encapsulation and unicast in accordance with a second embodiment of the present invention;

FIG. 9 is a flowchart of an operation of an ingress router in a DiffServ multicast method using encapsulation and unicast in accordance with a third embodiment of the present invention; and

FIG. 10 is a view of a structure of a multicast packet in accordance with another embodiment of the present invention.

### DETAILED DESCRIPTION OF THE INVENTION

Hereinafter, a DiffServ multicast system and method using encapsulation and unicast in accordance with a first embodiment of the present invention is described in more detail with reference to the accompanying drawings.

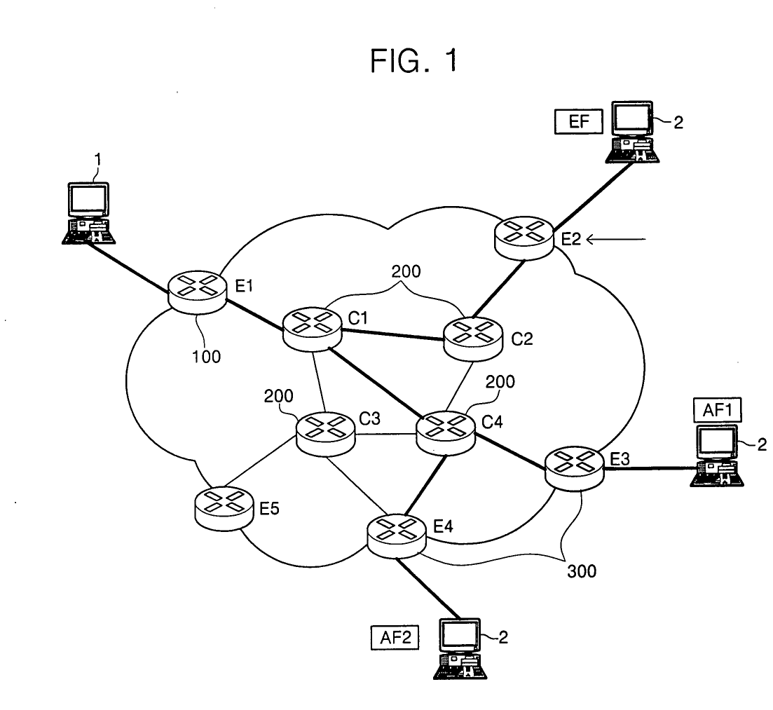

FIG. 1 is a view of a DiffServ multicast system using encapsulation and unicast in accordance with a first embodiment of the present invention. The DiffServ multicast system is composed of an ingress router 100, at least one core router 200 and at least one egress router 300.

The ingress router 100 generates a tree encapsulation header when receiving a multicast packet from a sender 1, activates an entry of the tree encapsulation header, and then transmits the multicast packet to the core router 200 or the egress router 300.

The core router 200 checks the activated entry from the tree encapsulation header when receiving the multicast packet including the tree encapsulation header from the ingress router 100, examines a routing table to duplicate the multicast packet as many times as the number of next routers connectable to the activated entry, and then changes an activation setting of the tree encapsulation header to transmit the multicast packet to another core router 200 or the egress router 300.

Furthermore, the egress router 300 removes the tree encapsulation header when receiving the multicast packet having the tree encapsulation header from the ingress router 100 or the core router 200, and then transmits the multicast packet to at least one receiver 2.

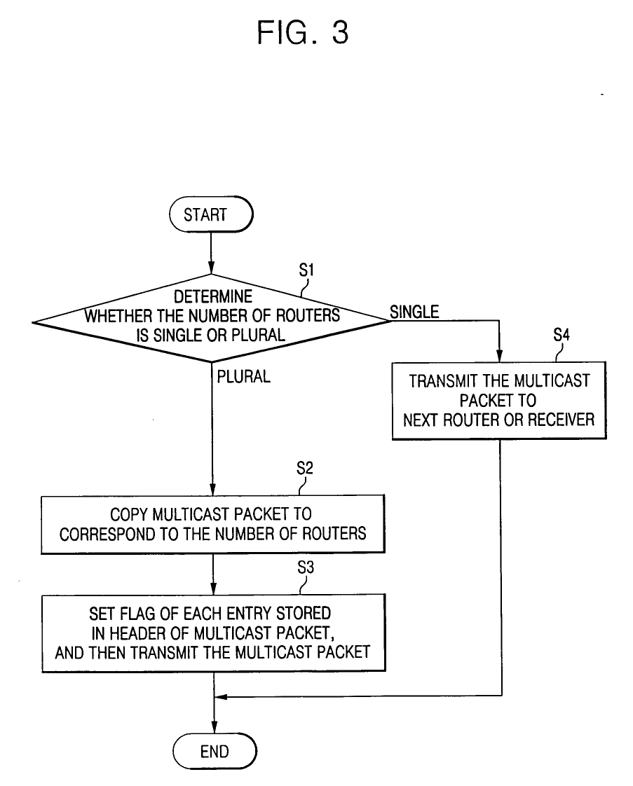

A DiffServ multicast method using encapsulation and unicast having a configuration as set forth above is described below with reference to FIG. 3.

First, when a multicast packet is received, a routing table is searched, and the number of routers capable of transmitting the multicast packet is determined (S1).

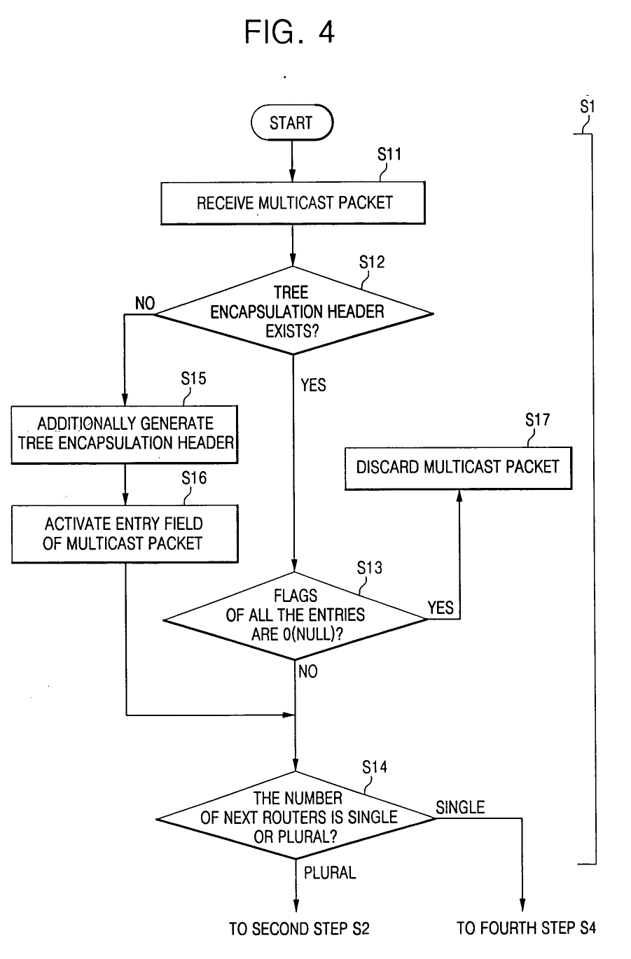

Hereinafter, an operation of the above-mentioned first step S1 is described in more detail with reference to FIG. 4.

A multicast packet is received (S11).

Subsequently, a determination is made as to whether or not a tree encapsulation header exists in the multicast packet (S12).

If the tree encapsulation header is determined to exist in the multicast packet in step S12, then the flag states of all of the entries stored in the tree encapsulation header of the multicast packet are determined (S13).

If the flags of all of the entries are determined to not be ‘0 (null)’ in step S13, then the routing table is searched and the number of next routers that should transmit the multicast packet is determined (S14).

If the tree encapsulation header is determined to not exist in step S12, then the tree encapsulation header is additionally generated with respect to a header of the multicast packet using members of the group and information on a level of requested service (S15).

Then, an entry field of the multicast packet to be transmitted through information of the routing table is activated, and it proceeds to step S16.

By contrast, if the flags of all the entry fields are determined to be ‘0’ in step S13, then the multicast packet is discarded (S17).

If it has been determined that the number of next routers capable of transmitting the multicast packet in step S1 is at least two, then the multicast packet is copied to correspond to the number of routers (S2).

Then, the entry connected to the next router is checked through the routing table, and the flag of each entry stored in the tree encapsulation header of the multicast packet is set and transmitted.

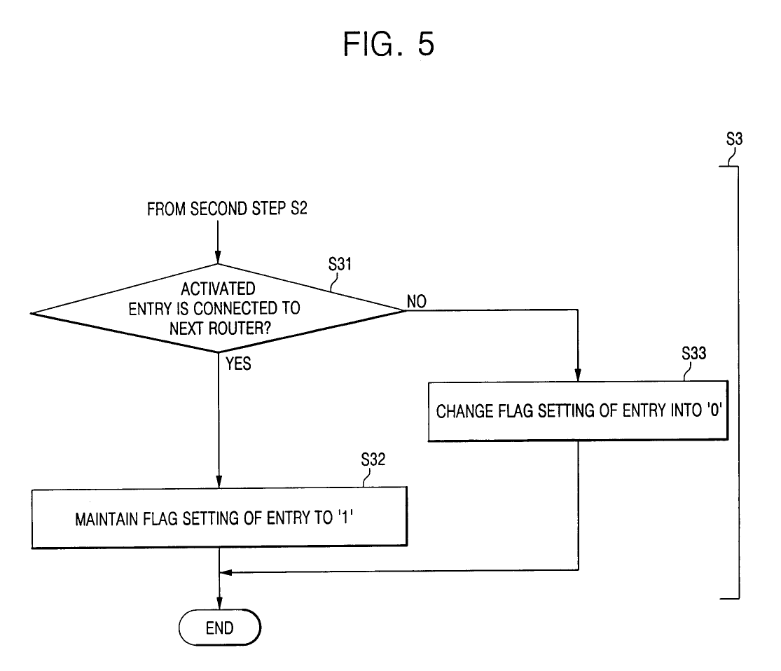

Hereinafter, an operation of the above-mentioned step S3 is described in more detail with reference to FIG. 5.

To begin with, a determination is made through the routing table as to whether or not the activated entry is connected to the next router (S31).

If the entry is determined to be connected to the next router in step S31, then the setting of the flag of the entry is maintained at ‘1’ (S32).

If the entry is determined to not be connected to the next router in step S31, then the setting of the flag of the entry is changed to a ‘0,’ and then the multicast packet is transmitted (S33).

By contrast, if it has been determined in step S1 that the number of next routers capable of transmitting the multicast packet is one, then the received multicast packet is transmitted to the corresponding router or receiver (S4).

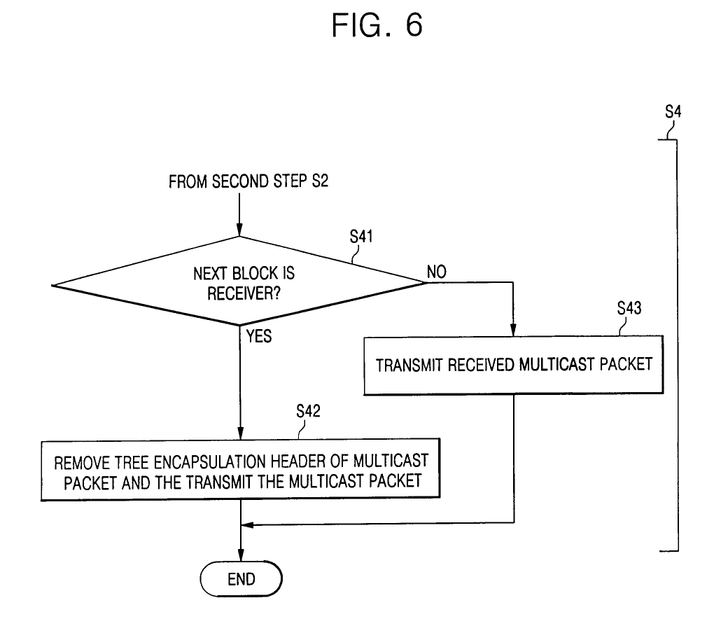

Hereinafter, an operation of the above-mentioned step S4 is described in more detail with reference to FIG. 6.

A determination is made as to whether or not the next block transmitting the multicast packet is the receiver (S11).

If the next block is determined to be the receiver in step S41, then the multicast packet gets its tree encapsulation header removed and is transmitted to the receiver (S42).

If the next block is the determined to be a router rather than the receiver in step S41, then the received multicast packet is transmitted (S43).

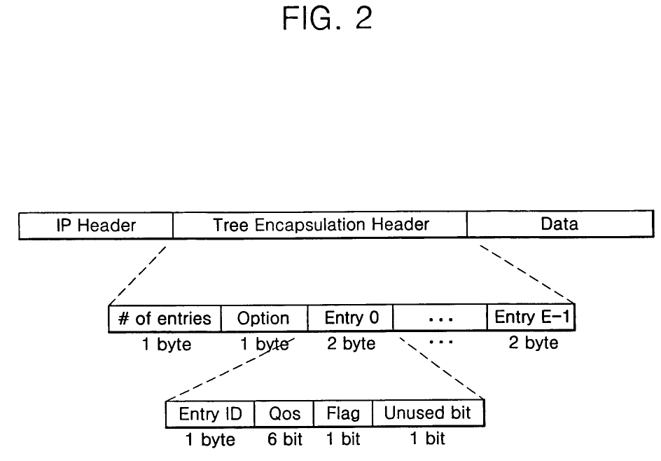

In steps S2 and S3, the multicast packet further includes the tree encapsulation header of FIG. 2. The multicast packet having the tree encapsulation header has 22+2E bytes, wherein E represents the number of egress routers 300 in the nodes constituting the multicast tree.

The tree encapsulation header includes the number of stored entries, options and at least one entry, wherein a field of the entry includes an identifier (ID) of the member, the QoS which the member requires, and information on the flag.

In the entry field of the tree encapsulation header, a field of the entry ID has 8 bits, a field of the QoS has 6 bits, and the flag is 1 bit.

A DiffServ multicast method using encapsulation and unicast in accordance with a second embodiment of the present invention is described below with reference to FIGS. 1 to 7, wherein the DiffServ multicast method has a configuration as set forth above.

First, as to a process of transmitting the multicast packet from the sender 1 to the receivers 2 (Receiver 1, Receiver 2 and Receiver 3), the ingress router 100 searches the routing table when the multicast packet is received from the sender 1, and determines the number of routers capable of transmitting the multicast packet (S1).

Hereinafter, an operation of the above-mentioned step S1 is described in more detail with reference to FIG. 4.

The ingress router 100 receives the multicast packet from the sender 1 (S11).

Subsequently, a determination is made as to whether or not the tree encapsulation header exists in the multicast packet (S12).

If the tree encapsulation header is determined not to exist in the multicast packet in step S12, then the tree encapsulation header is additionally generated with respect to the header of the multicast packet using the members of the group and information on the level of requested service (S15). The tree encapsulation header that the ingress router 1 generates includes the number of stored entries, options and at least one entry, as shown in FIG. 2, wherein a field of the entry includes an identifier (ID) of the member, the QoS which the member requires, and information on the flag. In the entry field of the tree encapsulation header, the field of the entry ID has 8 bits, the field of the QoS has 6 bits, and the flag is 1 bit.

The multicast packet further having the tree encapsulation header has 22+2E bytes, wherein E represents the number of egress routers 300 in the nodes constituting the multicast tree.

Subsequently, the ingress router 100 activates the entry field of the multicast packet to be transmitted through routing table (S16). In other words, the activation of the entry field is carried out by checking the receivers 2 (Receiver 1, Receiver 2 and Receiver 3) that are intended to transmit the multicast packet, searching the egress routers 300 (E2, E3 and E4) connected to the receivers 2 respectively, and activating the entry field. For example, the multicast packet transmitted from the sender 1 is transmitted to the receivers 2 (Receiver 1, Receiver 2 and Receiver 3) via the egress routers 300 (E2, E3 and E4) respectively.

Thus, the ingress router 100 checks such information through the routing table, causes the flags of the entries of Receiver 1, Receiver 2 and Receiver 3 in the entries of the multicast packet to be set to ‘1’ and activated, and then it proceeds to step S14.

The ingress router 100 searches the routing table to determine the number of next routers capable of transmitting the multicast packet (S14).

If the number of next routers capable of transmitting the multicast packet is determined to be one in step S1, then the ingress router 100 transmits the received multicast packet to the core router 200 (C1) (S4).

Hereinafter, an operation of the above-mentioned step S4 is described in more detail with reference to FIG. 6.

The ingress router 100 determines whether or not the next block transmitting the multicast packet is the receiver 2 (S41).

If the next block is determined to be the router in step S41, then the ingress router 100 transmits the received multicast packet to the core router 200 (C1) (S43).

Then, the core router 200 (C1) receiving the multicast packet from the ingress router 100 searches the header of the multicast packet to determine whether to process the multicast packet for itself, and determines the number of routers capable of transmitting the multicast packet through the search of the routing table (S1).

Hereinafter, an operation of step S1 is described in more detail with reference to FIG. 4.

The core router 200 (C1) receives the multicast packet from the ingress router 100 (S11).

Subsequently, the core router 200 (C1) determines whether or not the tree encapsulation header exists in the multicast packet (S12).

If the tree encapsulation header is determined to exist in step S12, then the core router 200 (C1) determines the flag states of all of the entries stored in the tree encapsulation header of the multicast packet (S13).

If the flags of all of the entries are determined not to be ‘0 (null)’ in step S13, then the core router 200 (C1) searches the routing table to determine the number of routers capable of transmitting the multicast packet (S14).

If the number of next routers capable of transmitting the multicast packet in step S1 is determined to be at least two, then the multicast packet is copied to correspond to the number of next routers (S2). In other words, the core router 200 (C1) checks the next router to which the multicast packet should be forwarded through the routing table. As a result, when the core router 200 (C1) confirms that the next routers 200 to which the multicast packet should be forwarded are two in number, the multicast packet is copied into two.

Subsequently, the core router 200 (C1) checks the entry connected to the next router using a result of routing performed previously, and sets the flag of each entry stored in the header of the multicast packet, and then transmits the copied multicast packets to the core routers 200 (C2 and C4), respectively (S3).

Hereinafter, an operation of the above-mentioned step S3 is described in more detail with reference to FIG. 5.

To begin with, the core router 200 (C1) determines through the routing table whether or not the activated entry is connected to the next router (S31).

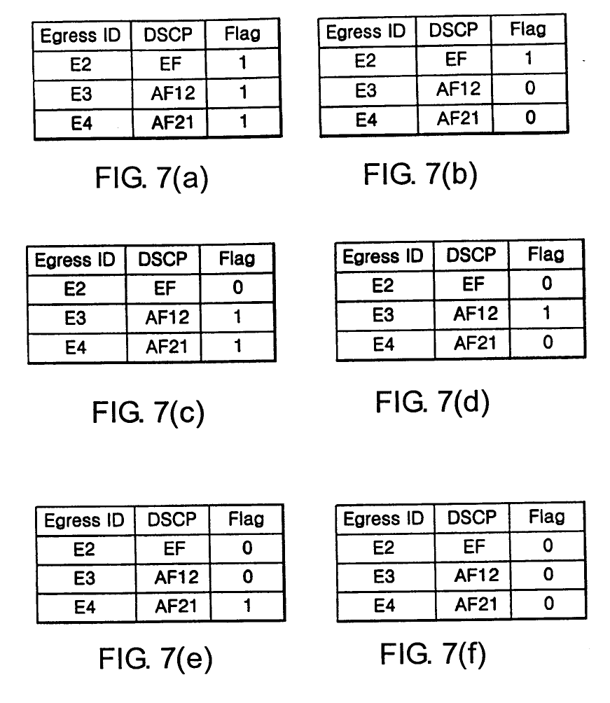

If the entry is determined to be connected to the next router in step S31, then the core router 200 (C1) maintains setting of the flag of the entry to ‘1’ (S32). Therefore, as shown in FIG. 7(a), only the entry flag of the egress router 300 (E2) connected to the receiver 2 (Receiver 1) among the entries of the multicast packet is maintained at ‘1’ so as to allow the multicast packet to be transmitted from the core router 200 (C1) to the receiver 2 (Receiver 1) through the core router 200 (C2).

However, if the entry is determined not to be connected to the next router in step S31, then the core router 200 (C1) changes setting of the flag of the entry to ‘0,’ and then transmits the multicast packet (S33). Therefore, as shown in FIG. 7(b), the core router 200 (C1) changes the flags of the other activated entries to ‘0,’ and transmits the multicast packet to the core router 200 (C2).

The core router 200 (C1) determines whether the activated entry is connected to the next router (S31).

If the activated entry is determined to be connected to the next router in step S31, then the core router 200 (C1) maintains the setting of the flag of the activated entry at ‘1’ (S32). Therefore, as shown in FIG. 7(e), only the entry flag of the egress router 300 (E4) connected to the receiver 2 (Receiver 3) among the entries of the multicast packet is maintained at ‘1’ so as to allow the multicast packet to be transmitted from the core router 200 (C1) to the receiver 2 (Receiver 1) through the core router 200 (C2). In other words, the core router 200 (C1) receives the same multicast packet as in FIG. 7(a), but it generates the same multicast packets as in FIGS. 7(b) and 7(c) to transmit the generated packets to the core routers C2 and C4 respectively.

The core router 200 (C1) determines whether the activated entry is connected to the next router (S31).

If the activated entry is determined to be connected to the next router in step S31, then the core router 200 (C1) maintains the setting of the flag of the activated entry at ‘1’ (S32). Therefore, as shown in FIG. 7(c), only the entry flags of the egress routers E3 and E4 connected to the receivers 2 (Receiver 2 and Receiver 3) among the entries of the multicast packet are maintained at ‘1’ so as to allow the multicast packet to be transmitted from the core router 200 (C1) to the receivers 2 (Receiver 2 and Receiver 3) through the core router 200 (C4).

However, if the entry is determined not to be connected to the next router in step S31, then the setting of the flag of the entry is changed to ‘0,’ and then the multicast packet is transmitted (S33). Thus, as shown in FIG. 7(c), the core router 200 (C1) causes the flags of the other activated entries to be changed to ‘0,’ and then transmits the multicast packet to the core router 200 (C4) (C1→C4).

Then, the core router 200 (C4) receiving the multicast packet from the core router 200 (C1) searches the routing table to determine the number of routers capable of transmitting the multicast packet (S1).

Hereinafter, an operation of step S1 is described in more detail with reference to FIG. 4.

The core router 200 (C4) receives the multicast packet from the core router 200 (C1) (S11).

Subsequently, the core router 200 (C4) determines whether or not the tree encapsulation header exists in the multicast packet (S12).

If the tree encapsulation header is determined to exist in step S12, then the core router 200 (C4) determines the flag states of all of the entries stored in the tree encapsulation header of the multicast packet (S13).

If the flags of all the entries are determined not to be ‘0 (null)’ in step S13, then the core router 200 (C4) searches the routing table to determine the number of routers capable of transmitting the multicast packet (S14).

If the number of next routers capable of transmitting the multicast packet in step S1 is determined to be at least two, then the core router 200 (C4) copies the multicast packet to correspond to the number of next routers (S2). In other words, the core router 200 (C4) gets information that three routers exist but it will do if the multicast packet is copied as a result of routing. Accordingly, the core router 200 (C4) copies the multicast packet into two and transmits them to the egress routers E3 and E4.

Subsequently, the core router 200 (C4) checks the entry connected to the next router through the routing table, and then sets the flag of each entry stored in the header of the multicast packet. Then, the core router 200 (C4) transmits the multicast packets to the egress routers 300 (E4 and E3), respectively (S3).

Hereinafter, an operation of the above-mentioned step S3 is described in more detail with reference to FIG. 5.

First, the core router 200 (C4) determines whether or not the activated entry is connected to the next router using the routing table (S31).

If it has been determined in step S31 that the activated entry is connected to the next router, then the core router 200 (C4) maintains the setting of the flag of the activated entry at ‘1’ (S32). Therefore, as shown in FIG. 7(e), only the entry flag of the egress router 300 (E4) connected to the receivers 2 (Receiver 3) among the entries of the multicast packet is maintained at ‘1’ so as to allow the multicast packet to be transmitted from the core router 200 (C4) to the receiver 2 (Receiver 3) via the egress router 300 (E4).

However, if it has been determined in step S31 that the entry is not connected to the next router, then the core router 200 (C4) changes the setting of the flag of the entry to ‘0,’ and then transmits the multicast packet (S33). Thus, as shown in FIG. 7(e), the core router 200 (C4) causes the flags of the other activated entries to be changed to ‘0,’ and then transmits the multicast packet to the egress router 300 (E4) (C4→E4).

The multicast packet arriving at the core router C4 has a format as shown in FIG. 7(c). Therefore, on performing routing, the core router C4 routes only the available receivers 2 (Receiver 2 and Receiver 3) regardless of the receiver 2 (Receiver 1). In this manner, the core router C4 looks for a path going to the egress routers E3 and E4, so that it copies the multicast packet into two and transmits them. The copied multicast packets have formats as shown in FIGS. 7(d) and 7(e), respectively. The multicast packet having a format as shown in FIG. 7(f) is never transmitted.

Then, the egress router 300 (E4) receiving the multicast packet from the core router 200 (C4) searches the routing table to determine the number of routers capable of transmitting the multicast packet (S1).

Hereinafter, an operation of the first step S1 is described in more detail with reference to FIG. 4.

The egress router 300 (E4) receives the multicast packet from the core router 200 (C4) (S11).

Subsequently, the egress router 300 (E4) determines whether or not the tree encapsulation header exists in the multicast packet (S12).

If it has been determined in step S12 that the tree encapsulation header exists, then the egress router 300 (E4) determines the flag states of all of the entries stored in the tree encapsulation header of the multicast packet (S13).

If it has been determined in step S13 that the flags of all of the entries are not ‘0 (null)’, then the egress router 300 (E4) searches the routing table to determine the number of routers capable of transmitting the multicast packet (S14).

If it has been determined in step S1 that the number of next routers capable of transmitting the multicast packet is one, then the egress router 300 (E4) transmits the received packet to the receiver 2 (Receiver 3) (S4).

Hereinafter, an operation of the above-mentioned fourth step S4 is described in more detail with reference to FIG. 6.

The egress router 300 (E4) determines whether or not the next block transmitting the multicast packet is the receiver 2 (S41).

If it has been determined in step S41 that the next block is the receiver 2, then the egress router 300 (E4) removes the tree encapsulation header of the multicast packet, and then transmits the multicast packet to the receiver 2 (Receiver 3) (S42).

Then, the egress router 300 (E3) receiving the multicast packet from the core router 200 (C4) searches the routing table to determine the number of routers capable of transmitting the multicast packet (S1).

Hereinafter, an operation of the first step S1 is described in more detail with reference to FIG. 4.

The egress router 300 (E3) receives the multicast packet from the core router 200 (C4) (S11).

Subsequently, the egress router 300 (E3) determines whether or not the tree encapsulation header exists in the multicast packet (S12).

If it has been determined in step S12 that the tree encapsulation header exists, then the egress router 300 (E3) determines the flag states of all of the entries stored in the tree encapsulation header of the multicast packet (S13).

If it has been determined in step S13 that the flags of all of the entries are not ‘0 (null)’, then the egress router 300 (E3) searches the routing table to determine the number of routers capable of transmitting the multicast packet (S14).

If it has been determined in step S1 that the number of next routers capable of transmitting the multicast packet is one, then the egress router 300 (E3) transmits the received packet to the receiver 2 (Receiver 3) (S4).

Hereinafter, an operation of the above-mentioned fourth step S4 is described in more detail with reference to FIG. 6.

The egress router 300 (E3) determines whether or not the next block transmitting the multicast packet is the receiver 2 (S41).

If it has been determined in step S41 that the next block is the receiver 2, then the egress router 300 (E3) removes the tree encapsulation header of the multicast packet, and then transmits the multicast packet to the receiver 2 (Receiver 2) (S42).

Then, the egress router 300 (E2) receiving the multicast packet from the core router 200 (C2) searches the routing table to determine the number of routers capable of transmitting the multicast packet (S1).

Hereinafter, an operation of the first step S1 is described in more detail with reference to FIG. 4.

The egress router 300 (E2) receives the multicast packet from the core router 200 (C2) (S11).

Subsequently, the egress router 300 (E2) determines whether or not the tree encapsulation header exists in the multicast packet (S12).

If it has been determined in step S12 that the tree encapsulation header exists, then the egress router 300 (E2) determines the flag states of all of the entries stored in the tree encapsulation header of the multicast packet (S13).

If it has been determined in step S13 that the flags of all of the entries are not ‘0 (null)’, then the egress router 300 (E2) searches the routing table to determine the number of routers capable of transmitting the multicast packet (S14).

If it has been determined in the first step S1 that the number of next routers capable of transmitting the multicast packet is one, then the egress router 300 (E2) transmits the received packet to the receiver 2 (Receiver 1) (S4).

Hereinafter, an operation of the above-mentioned step S4 is described in more detail with reference to FIG. 6.

The egress router 300 (E2) determines whether or not the next block transmitting the multicast packet is the receiver 2 (S41).

If it has been determined in step S41 that the next block is the receiver 2, then the egress router 300 (E2) removes the tree encapsulation header of the multicast packet, and then transmits the multicast packet to the receiver 2 (Receiver 1) (S42).

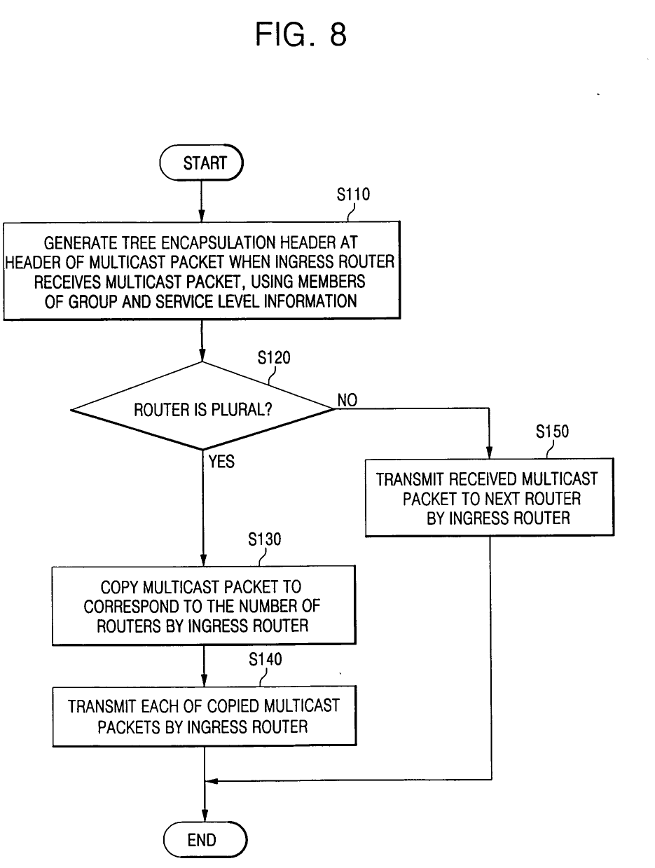

A DiffServ multicast method using encapsulation and unicast in accordance with a second embodiment of the present invention is described below with reference to FIG. 8, wherein the DiffServ multicast method has a configuration as set forth above.

To begin with, when receiving a multicast packet, the ingress router 100 generates a tree encapsulation header at the multicast packet using members of a group and information on a level of requested service (S110).

The ingress router 100 determines, through a search of a routing table, whether the number of routers capable of transmitting the multicast packet is one or at least two (S120).

If it has been determined in step S120 that the number of routers capable of transmitting the multicast packet is at least two, then the ingress router 100 copies the multicast packet to correspond to the number of routers (S130).

Subsequently, the ingress router 100 transmits the copied multicast packets to the next routers, respectively (S140).

If it has been determined in step S120 that the number of routers capable of transmitting the multicast packet is one, then the ingress router 100 transmits the received multicast packet to the next router (S150).

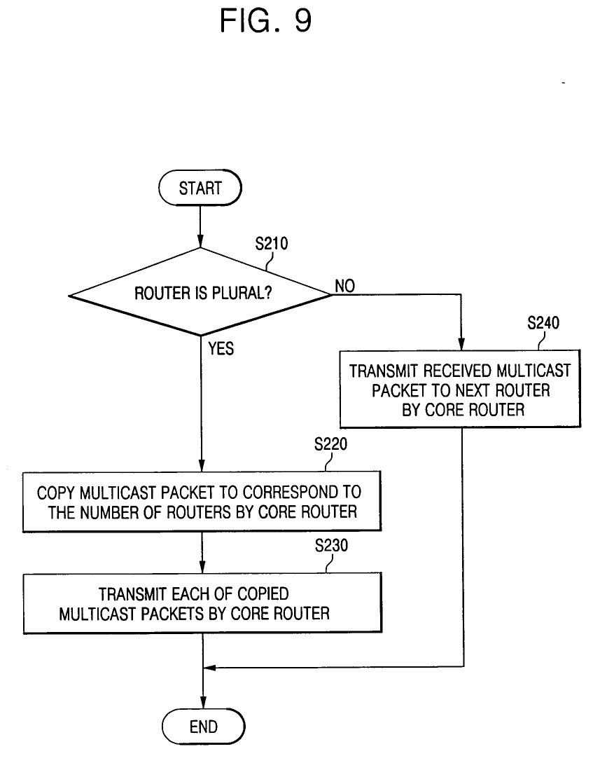

A DiffServ multicast method using encapsulation and unicast in accordance with a third embodiment of the present invention is described below with reference to FIG. 9, wherein the DiffServ multicast method has a configuration as set forth above.

When receiving a multicast packet, the core router 200 determines, through search of a routing table, whether the number of routers capable of transmitting the multicast packet is one or at least two (S210).

If it has been determined in step S210 that the number of routers capable of transmitting the multicast packet is at least two, then the core router 200 copies the multicast packet to correspond to the number of routers (S220).

Subsequently, the core router 200 transmits each of the copied multicast packets (S230).

If it has been determined in step S210 that the number of routers capable of transmitting the multicast packet is one, then the core router 200 transmits the received multicast packet to the next router (S240).

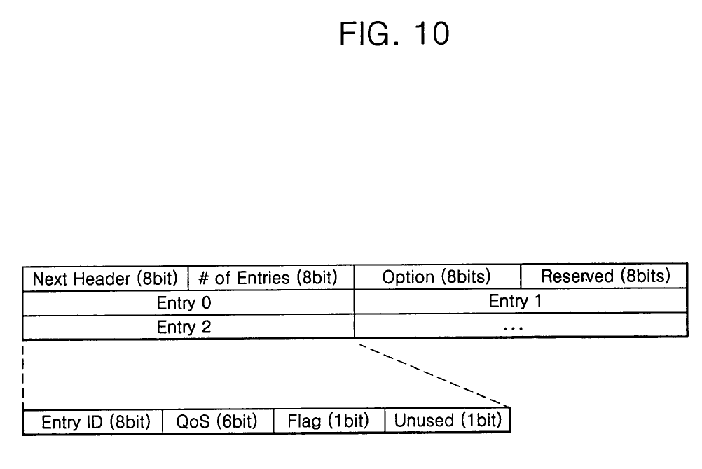

Furthermore, as shown in FIG. 10, the present invention extends the tree encapsulation header with IPv6, thereby being capable of adding the tree encapsulation header to an IPv6 extension header.

Although exemplary embodiments of the present invention have been described, it will be understood by those skilled in the art that the present invention is not limited to the described exemplary embodiments. Rather, various changes and modifications can be made within the spirit and scope of the present invention, as defined by the following claims.

As mentioned above, with the DiffServ multicast method using encapsulation and unicast in accordance with the present invention, it is possible to maintain advantages of the DiffServ and the multicast with no change, reduce throughput and data overhead of the ingress router within the network, and apply changes of the network, group members and routing information with rapidity. It is therefore possible to improve performance of the network.

Since information on the multicast tree and the QoS depending on changes of the group to which the ingress router should provide services, of tree information, and of topology need not be managed and updated, it is possible to reduce throughput and data overhead of the ingress router.

Even when changes of the group and the network take place, it does not matter that the ingress router does not update information of all of the trees. Hence, it is possible to quickly cope with changes of the network and group members as well as to improve the overall performance.

It is possible to maintain scalability and simultaneously maintain various service supports, and allow simplification of resource reservation issues which each receiver requires without any damage.

What is claimed is:

1. A Differentiated Services (DiffServ) multicast method using encapsulation and unicast, comprising:
searching a routing table according to information of a header of a multicast packet to determine the number of routers capable of transmitting the multicast packet upon the multicast packet being received;
copying the multicast packet to correspond to the number of routers determined to be capable of transmitting the multicast packet upon the multicast packet being received; and
checking an entry connected to the next router through the routing table, setting a flag of each entry stored in the header of the multicast packet, and transmitting the multicast packet.

2. The multicast method of claim 1, further comprising transmitting the received multicast packet to the corresponding router or receiver upon the number of next routers capable of transmitting the multicast packet having been determined to be one.

3. The multicast method of claim 1, wherein searching a routing table according to information of a header of a multicast packet to determine the number of routers capable of transmitting the multicast packet upon the multicast packet being received comprises:
receiving the multicast packet;
determining whether or not a tree encapsulation header exists in the multicast packet;
determining the states of flags of all of the entries stored in the tree encapsulation header of the multicast packet upon a determination that the tree encapsulation header exists in the multicast packet; and
searching the routing table to determine the number of routers capable of transmitting the multicast packet upon a determination that the flags of all the entries are not activated.

4. The multicast method of claim 3, further comprising:
additionally generating the tree encapsulation header at a header of the multicast packet using members of a group and information on a level of requested service upon a determination that the tree encapsulation header does not exist; and
activating a field of the entry of the multicast packet to be transmitted through the routing table and proceeding to searching the routing table to determine the number of routers capable of transmitting the multicast packet upon a determination that the flags of all the entries are not activated.

5. The multicast method of claim 3, further comprising discarding the multicast packet upon a determination that the flags of all the entries have not been activated.

6. The multicast method of claim 1, wherein checking an entry connected to the next router through the routing table, setting a flag of each entry stored in the header of the multicast packet, and transmitting the multicast packet comprises:
determining whether or not the activated entry is connected to the next router using the routing table; and
maintaining the setting of the flag of the activated entry in an activated state upon a determination that the activated entry has been connected to the next router.

7. The multicast method of claim 6, further comprising changing the setting of the flag of the activated entry into an inactivated state upon a determination that the activated entry is not connected to the next router,

8. The multicast method of claim 2, wherein transmitting the received multicast packet to the corresponding router or receiver upon the number of next routers capable of transmitting the multicast packet having been determined to be one comprises:
determining whether a next block transmitting the multicast packet is the receiver; and
removing the tree encapsulation header of the multicast packet and then transmitting the multicast packet upon a determination that the next block is the receiver.

9. The multicast method of claim 8, further comprising transmitting the received multicast packet upon a determination that the next block is the router.

10. The multicast method of claim 1, wherein, in copying the multicast packet to correspond to the number of routers determined to be capable of transmitting the multicast packet upon the multicast packet being received and checking an entry connected to the next router through the routing table, setting a flag of each entry stored in the header of the multicast packet, and transmitting the multicast packet, the multicast packet additionally includes the tree encapsulation header.

11. The multicast method of claim 10, wherein the tree encapsulation header includes position information of members, options and at least one entry.

12. The multicast method of claim 10, wherein a header of the multicast packet having the tree encapsulation header includes an IP header of 20 bytes and the tree encapsulation header of 2+2E bytes.

13. The multicast method of claim 11, wherein a field of the entry in the tree encapsulation header includes an identifier of a member, Quality of Service (QoS) required by the member, and flag information.

14. The multicast method of claim 13, wherein a field of the entry identifier in the tree encapsulation header has 8 bits.

15. The multicast method of claim 13, wherein a field of the QoS in the tree encapsulation header has 6 bits.

16. The multicast method of claim 13, wherein the flag in the tree encapsulation header has 1 bit.

17. The multicast method of claim 12, wherein E in the multicast data packet represents the number of egress routers in nodes constituting a multicast tree.

18. A Differentiated Services (DiffServ) multicast method using encapsulation and unicast, comprising:
generating a tree encapsulation header at a header of a multicast packet using members of a group and information on a level of requested service upon an ingress router receiving the multicast packet;
determining, through search of a routing table, whether the number of routers capable of transmitting the multicast packet is one or at least two by the ingress router;
copying the multicast packet to correspond to the number of routers by the ingress router upon a determination that the number of routers capable of transmitting the multicast packet is at least two; and
transmitting each of the copied multicast packets by the ingress router.

19. The multicast method of claim 18, further comprising transmitting the received multicast packet to a next router by the ingress router upon a determination that the number of routers capable of transmitting the multicast packet is one.

20. A Differentiated Services (DiffServ) multicast method using encapsulation and unicast, comprising:
determining, through search of a routing table, whether the number of routers capable of transmitting the multicast packet is one or at least two by the core router upon a core router receiving a multicast packet;
copying the multicast packet to correspond to the number of next routers by the core router upon a determination that the number of next routers capable of transmitting the multicast packet is at least two; and
transmitting each of the copied multicast packets by the core router.

21. The multicast method of claim 20, further comprising transmitting the received multicast packet to a next router by the core router upon a determination that the number of next routers capable of transmitting the multicast packet is one.

22. A Differentiated Services (DiffServ) multicast system using encapsulation and unicast, comprising:
an ingress router adapted to generate a tree encapsulation header upon receiving a multicast packet from a sender and to activate an entry of the tree encapsulation header to transmit the multicast packet to a next router;
at least one core router adapted to check the activated entry from the tree encapsulation header, to examine a unicast routing table to copy the multicast packet by the number of next routers connectable to the activated entry, and to change an activation setting of the tree encapsulation header to transmit the copied multicast packet; and
at least one egress router adapted to remove the tree encapsulation header upon receiving the multicast packet having the tree encapsulation header, and to transmit the multicast packet to each receiver.

23. The multicast system of claim 22, wherein the ingress router is adapted to generate the tree encapsulation header upon receiving the multicast packet and to include the tree encapsulation header in a header of the multicast packet.

24. The multicast system of claim 23, wherein the tree encapsulation header includes position information of members, options and at least one entry.

25. The multicast system of claim 24, wherein a header of the multicast packet having the tree encapsulation header includes an IP header of 20 bytes and the tree encapsulation header of 2+2E bytes.

26. The multicast system of claim 24, wherein information included in the entry in the tree encapsulation header includes at least one of an identifier of a member, Quality of Service (QoS) required by the member, and flag information.

27. The multicast system of claim 26, wherein a field of the entry identifier in the tree encapsulation header has 8 bits.

28. The multicast system of claim 26, wherein a field of the QoS in the tree encapsulation header has 6 bits.

29. The multicast system of claim 24, wherein the flag in the tree encapsulation header has 1 bit.

30. The multicast system of claim 25, wherein E in the multicast data packet represents the number of egress routers in nodes constituting a multicast tree.

31. A Differentiated Services (DiffServ) multicast system using encapsulation and unicast, comprising:
an ingress router adapted to, upon routing information being changed, update information on a router tree to manage information on all multicast trees, and, upon a multicast packet being received from a sender, to search information on the corresponding multicast tree to generate a tree encapsulation header, and to store the tree encapsulation header in the multicast packet and transmit the multicast packet; and
at least one core router adapted to, upon the multicast packet being received from the ingress router, parse the tree encapsulation header of the multicast packet to transmit the multicast packet to a destination.

32. The multicast system of claim 31, wherein the tree encapsulation header includes position information of members, options and at least one entry.

33. The multicast system of claim 32, wherein a field of the entry includes an entry identifier of 1 byte, entry information to be copied of 6 bits, and Quality of Service Information (QoS) of each entry of 3 bits.

34. A Differentiated Services (DiffServ) multicast method using encapsulation and unicast, the method comprising:
transmitting an IPv6 packet; and
receiving the IPv6 packet;
wherein the IPv6 packet includes a tree encapsulation header.
